(19) United States
(12) Patent Application Publication
(10) Pub. No.: US 2018/0031239 A1
(43) Pub. Date: Feb. 1, 2018

(54) COMBUSTOR CAP ASSEMBLY AND METHODS OF MANUFACTURE

(71) Applicant: Allied Power Group, LLC, Houston, TX (US)

(72) Inventors: AARON FROST, CYPRESS, TX (US); ANDREW CARTER, HOUSTON, TX (US)

(21) Appl. No.: 15/662,405

(22) Filed: Jul. 28, 2017

Related U.S. Application Data
(60) Provisional application No. 62/367,735, filed on Jul. 28, 2016.

(51) Int. Cl. F23R 3/00; B23P 15/00; F23R 3/28; F23R 3/06; F23R 3/42

(52) U.S. Cl. CPC F23R 3/005; F23R 3/06; F23R 3/42; F23R 3/286; B23P 15/008

(57) ABSTRACT

The present invention discloses a combustor cap assembly and associated manufacturing process. The process provides a way of forming a dome plate of the cap assembly having improved cooling hole shapes and elimination of potential crack initiation points known to contribute to failures in prior art combustor cap assemblies.

### CROSS-REFERENCE TO RELATED APPLICATIONS

This application claims priority to U.S. Provisional Patent Application Ser. No. 62/367,735 filed on Jul. 28, 2016.

### TECHNICAL FIELD

The present invention relates generally to a combustion system. More specifically the present invention relates to a system and method of manufacturing a cap assembly for the combustion system.

### BACKGROUND OF THE INVENTION

In a typical gas turbine engine used in a power plant application, an axial multi-stage compressor receives a supply of air and compresses the air to increase the air pressure and temperature. The compressed air passes to one or more combustors arranged in an annular array about a centerline of the engine. The combustors add fuel to the compressed air to create a fuel/air mixture, and ignite the mixture to produce hot combustion gases. The hot combustion gases exit the one or more combustors and enter an axial turbine, where the gases expand and are utilized to drive the turbine. The turbine is coupled to the compressor through a shaft. The engine shaft is also coupled to a shaft that drives a generator for generating electricity.

The compressor and turbine sections each include a plurality of rotating blades fixed to stages of rotating disks. Spaced between each stage of rotating blades is a stage of stationary airfoils, also known as vanes. The vanes are secured within a compressor or turbine case. A portion of a typical engine is shown in cross section in FIG. 1.

The one or more combustors typically include a plurality of combustors, each with an end cap for engaging a plurality of fuel nozzles. The fuel nozzles provide a fuel supply to the combustion system, where the fuel mixes with air. The fuel-air mixture is ignited resulting in hot combustion gases which are then directed to the turbine, where the rotation of the turbine then drives the compressor. Due to the proximity of the end cap relative to the ignition point, it is necessary to cool the end cap.

Advancements in cooling technologies have resulted in more complex air patterns being used to cool combustor cap assemblies. For example, certain prior art combustor caps use a plurality of laser drilled holes in a plate adjacent the combustion area through which cooling air flows. However, these cooling holes are often drilled prior to finishing cap assembly manufacturing. Subsequent manufacturing steps often require welding, which can distort cooling hole positioning and size, resulting in non-uniform cooling, as well as other part defects including, but not limited to, cracking in cooling hole locations, recast in the cooling holes, slag, and micro-cracks in critical surface locations.

### SUMMARY

The present invention discloses systems and methods for improving the manufacture of a combustor end cap.

In an embodiment of the present invention, a cap assembly for a gas turbine engine is provided comprising an outer ring, a dome plate having a plurality of openings with a plurality of formed edges around the plurality of openings and a formed lip around a perimeter of the dome plate, an outer band secured to the formed lip, and a plurality of fuel tubes secured to each of the plurality of openings. The fuel tubes are secured such that fuel cups have a constant diameter proximate the plurality of openings so as to provide a uniform weld joint for securing the fuel tubes to the formed edges. The cap assembly has a plurality of cooling holes generally equally spaced about the formed lip, where the plurality of cooling holes have a constant circular shape.

In an alternate embodiment of the present invention, a method of fabricating a dome plate for a combustor cap assembly is provided. The method comprises cutting a plurality of rough openings in the dome plate for a plurality of fuel tubes, forming a lip around a perimeter of the dome plate, forming a fuel tube edge around each of the rough openings, and drilling a plurality of cooling holes in the dome plate. A portion of the plurality of cooling holes are drilled in the lip of the dome plate.

Additional advantages and features of the present invention will be set forth in part in a description which follows, and in part will become apparent to those skilled in the art upon examination of the following, or may be learned from practice of the invention. The instant invention will now be described with particular reference to the accompanying drawings.

### BRIEF DESCRIPTION OF THE SEVERAL VIEWS OF THE DRAWINGS

The present invention is described in detail below with reference to the attached drawing figures, wherein:

FIG. 1 is a partial cross section view of a gas turbine engine on which an embodiment of the present invention may be used.

FIG. 2A is a detailed elevation view of a portion of a dome plate of an end cap of the prior art.

FIG. 2B is an alternate detailed elevation of a portion of a dome plate of an end cap of the prior art.

FIG. 3A is a partial perspective view of a lip of an end cap of the prior art.

FIG. 3B is a partial cross section view of the lip of FIG. 3A.

FIG. 4 is a perspective view of a combustor cap assembly in accordance with an embodiment of the present invention.

FIG. 5 is a detailed perspective view of a portion of the combustor cap assembly of FIG. 4.

FIG. 6 is an elevation view of a partially-assembled end cap assembly in accordance with an embodiment of the present invention.

FIG. 7 is a perspective view of a dome plate in accordance with an embodiment of the present invention.

FIG. 8 is a cross section view through a lip portion of the dome plate in accordance with an embodiment of the present invention.

FIG. 9 is a perspective view of a fuel tube secured to a dome plate in accordance with an embodiment of the present invention.

FIG. 10 is a partial elevation view of a dome plate in accordance with an embodiment of the present invention.

FIG. 11 is a detailed partial elevation view depicting cooling holes in the dome plate in accordance with an embodiment of the present invention.

FIG. 12 is a flow diagram describing a process in accordance with an embodiment of the present invention.

FIG. 13A is a perspective view of a cap assembly with a dome plate removed in accordance with an embodiment of the present invention.

FIG. 13B is an elevation view of tool used with the cap assembly of FIG. 13A.

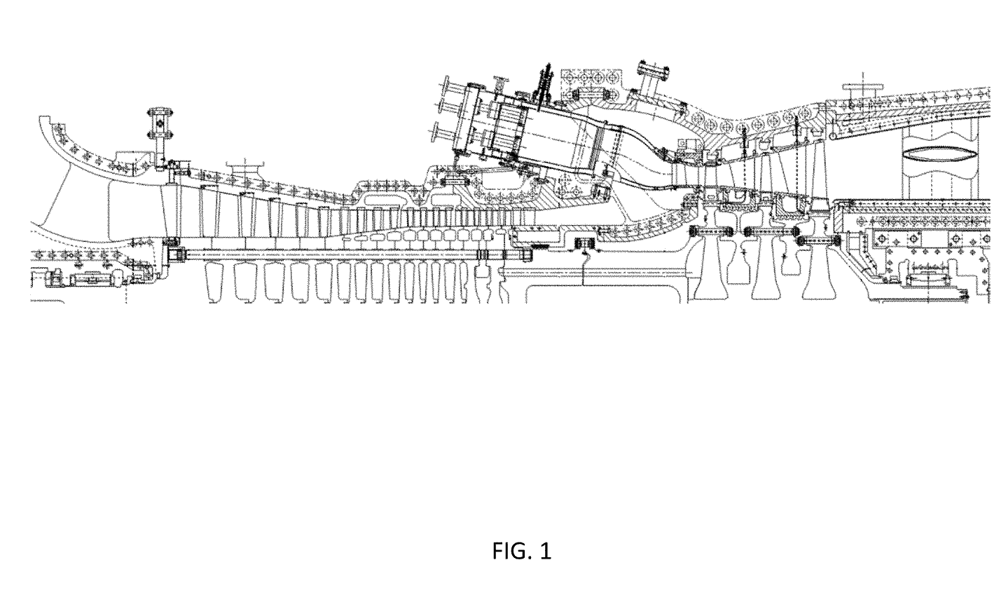

### DETAILED DESCRIPTION

The present invention discloses a system and method for improving the manufacturing and resulting life of a cap assembly for use in a gas turbine combustor. The cap assembly provides a mechanism through which fuel and air can be injected and mixed for burning in the combustor. Due to the proximity of the cap assembly to the flame front, it is necessary to cool the face, or dome plate, of the cap assembly. To effectively utilize the cooling air provided, multiple, small cooling holes are placed throughout a dome plate, including in a bend region, or lip of the dome plate.

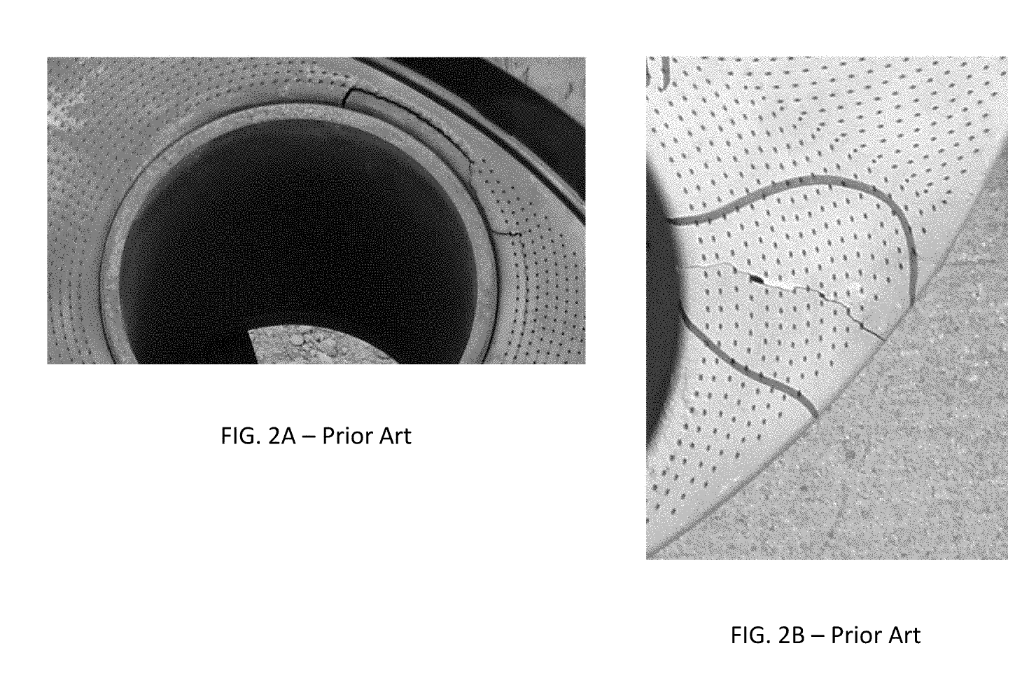

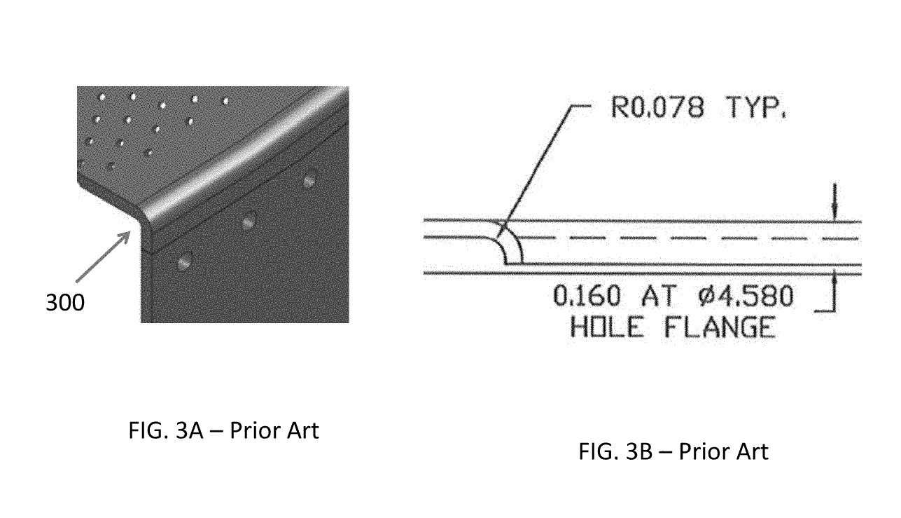

However, manufacturing processing shortcuts in prior art combustor caps have led to cracks in the dome plate and failures of the cap assembly, as shown in FIGS. 2A and 2B. For example, a prior art dome plate of a cap assembly is formed by laser drilling the cooling holes in the dome plate when the dome plate is in a flat pattern and then forming the dome plate to the desired shape via a press and die or other acceptable tooling. As a result of forming the dome plate into its final shape after the holes are drilled, the shape of the cooling holes can be altered, thereby imparting stresses into the cooling hole regions, and even resulting in micro-cracks in the dome plate. Altering the cooling hole shape can adversely affect the localized cooling by not providing the required amount of cooling air. An altered cooling hole via a forming process may also introduce micro-cracks which can lead to cracking of the dome plate, as exhibited in FIGS. 2A and 2B. An example of the prior art dome plate cooling hole and lip formation is shown in FIGS. 3A and 3B. This prior art configuration operates at approximately 158 ksi peak stress in the radius 300 of FIGS. 3A and 3B.

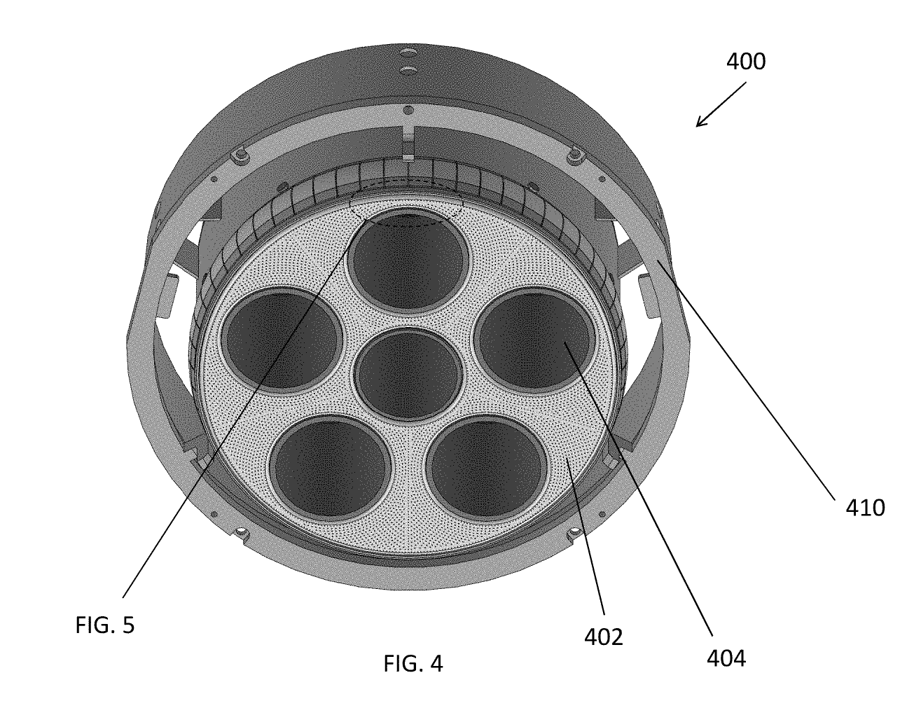

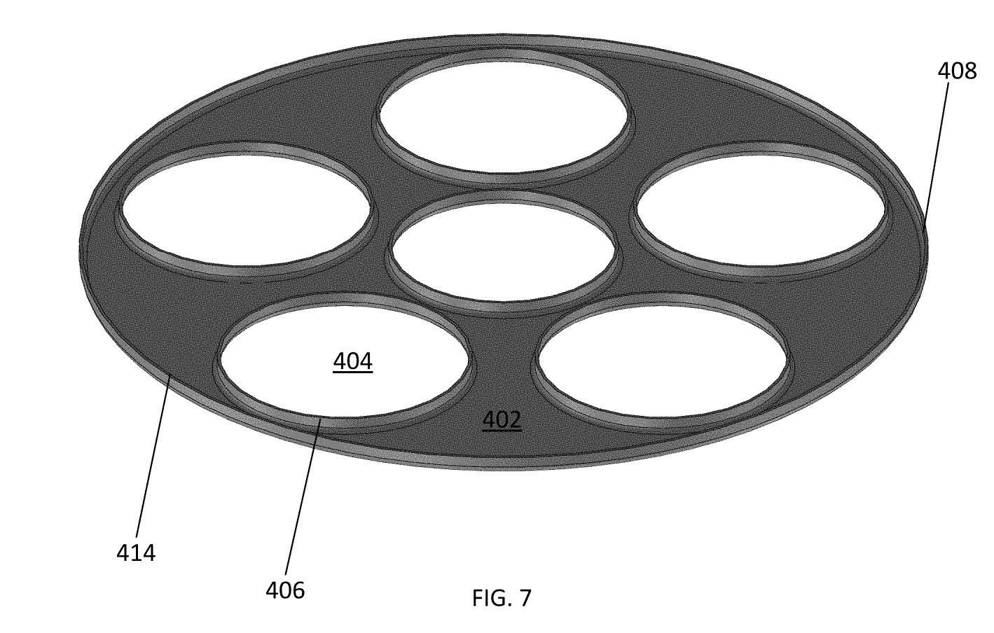

Referring now to FIGS. 4-7, an embodiment of the present invention is depicted. A cap assembly 400 having a dome plate 402 is shown in perspective view. The dome plate 402 has a plurality of openings 404 spaced in an annular array about the dome plate 402. Each of the openings 404 has a formed edge 406 around the opening 404 as well as a formed lip 408 around a perimeter of the dome plate 402. As it can be seen from FIG. 7, the formed edges 406 and formed lip 408 are placed in the dome plate 402 prior to any cooling holes being drilled.

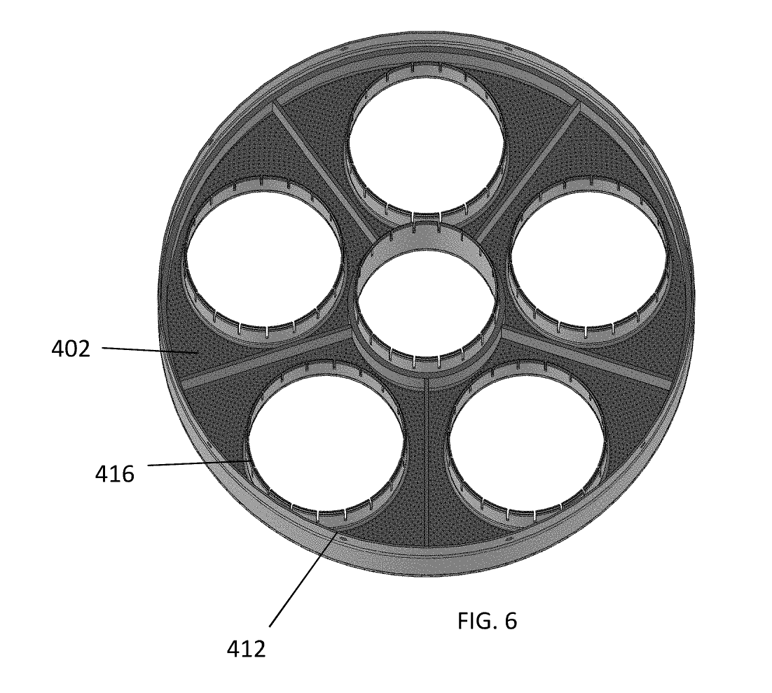

Referring back to FIG. 4, an outer ring 410 is positioned about the dome plate 402 and used to secure the cap assembly to the combustor (not shown). Referring to FIGS. 6 and 7, an outer band 412 is secured to the edge 414 of lip 408. The outer band 412 is preferably secured by way of welding. The lip 408 is of sufficient height such that the weld to the outer band 412 is far enough away from the cooling holes that heat induced into the part during welding does not adversely alter the size or shape of the cooling holes in the lip 408. It has been determined that a sufficient height of lip 408 is at least eight times the thickness of the dome plate 402. That is, for a dome plate having a thickness of 0.075 inches, the height of the lip 408 is preferably 0.625 inches.

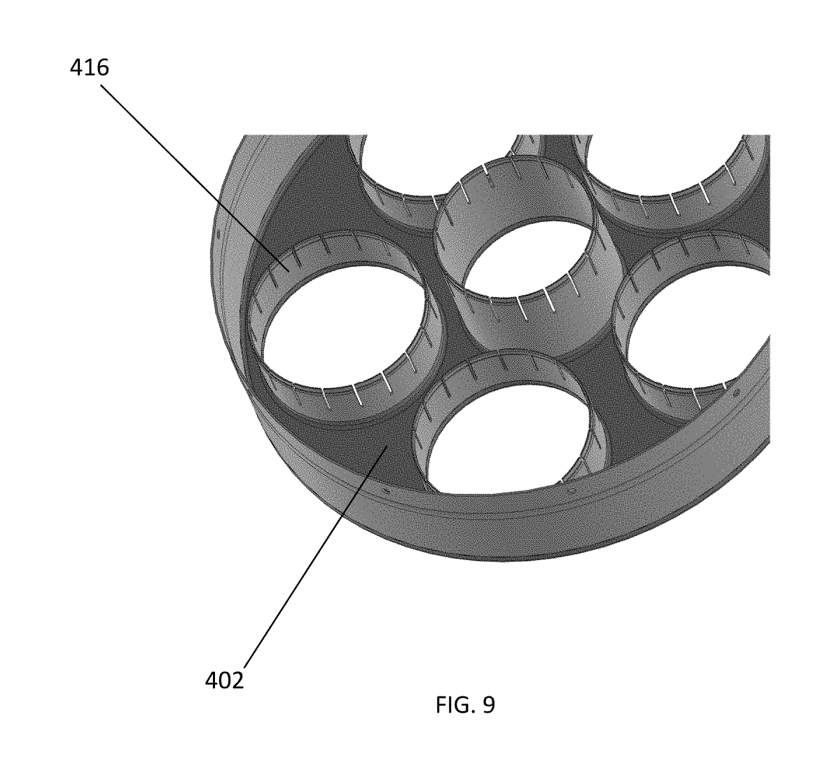

As shown in FIGS. 6 and 9, the cap assembly 400 also includes a plurality of fuel tubes 416. Prior art fuel tubes were typically rolled and welded from sheet metal. The rolling and welding process often did not produce a completely round tube, thus creating a mismatch when assembling the fuel tube to the dome plate. The fuel tubes 416 of the present invention are instead fabricated using an extrusion process thereby eliminating any welding within the tube itself and ensuring a constant diameter tube is welded to a constant diameter opening in the dome plate 402. The fuel tubes 416 are secured to the dome plate 402 at each of the plurality of openings 404, preferably by welding.

As with the height of lip 408, the same is true for a height of the formed edges 406. To eliminate any adverse effects from welding of the fuel tubes 416 to the formed edges 406, the height of the formed edges 406 should be a distance equal to at least eight times the material thickness of the dome plate 402. Thus, for a dome plate having a thickness of 0.075 inches, the formed edges should extend a height of at least 0.625 inches.

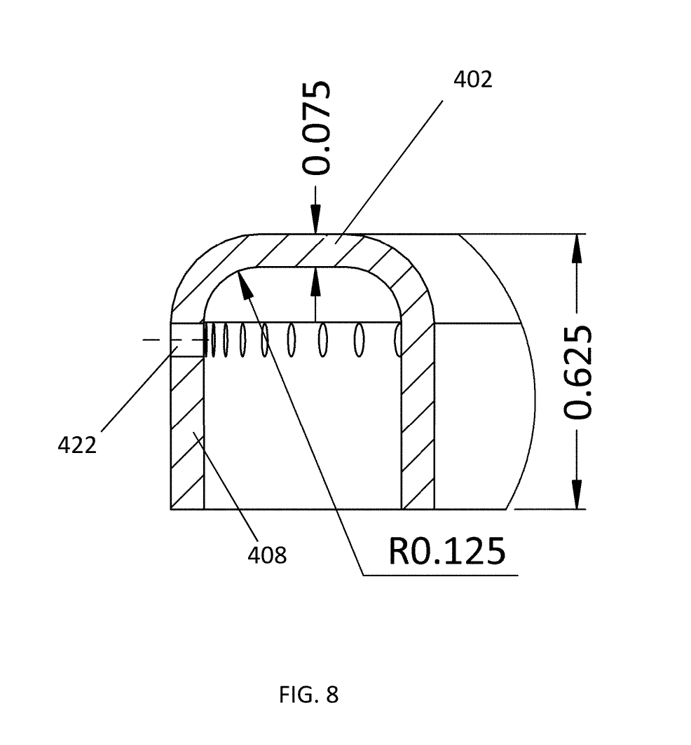

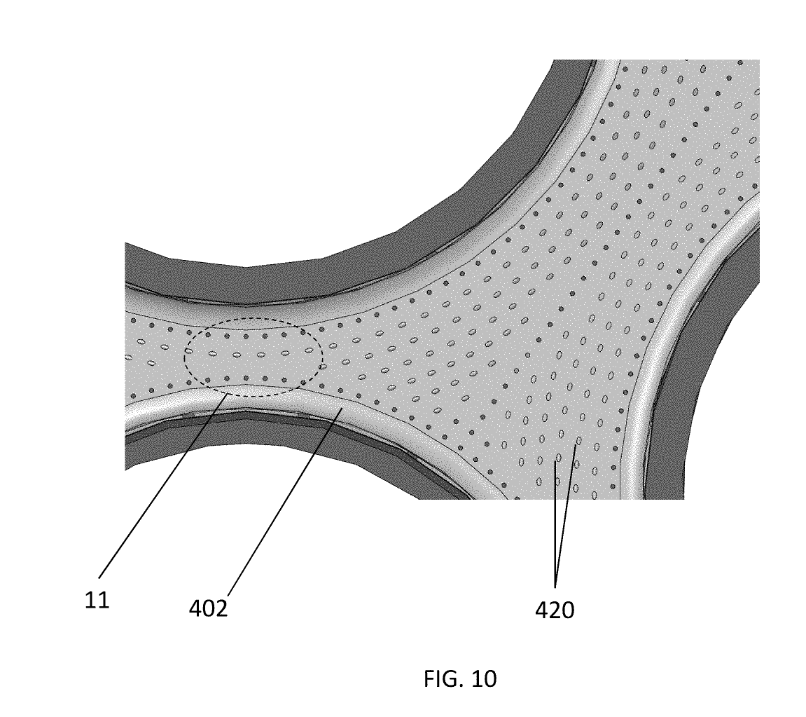

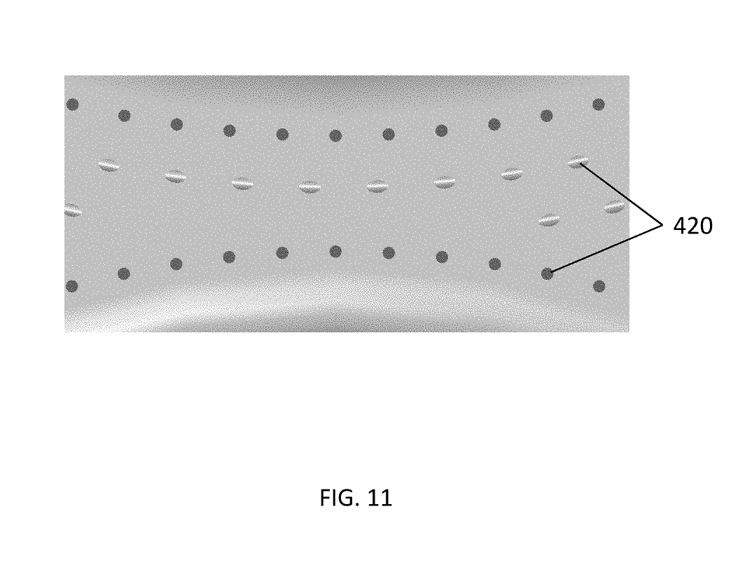

Referring now to FIGS. 8, 10, and 11, details of the cooling holes associated with the dome plate 402 are shown. As depicted in FIG. 10, the dome plate 402 comprises a plurality of cooling holes 420. For the embodiment shown in FIG. 10, the dome plate 402 comprises approximately 4645 cooling holes each having a diameter of approximately 0.031 in. These cooling holes 420 are drilled by a laser into the previously-formed dome plate 402. The cooling holes 420 are drilled perpendicular to the surface of dome plate 402 as well as at a surface angle, as shown in FIG. 11.

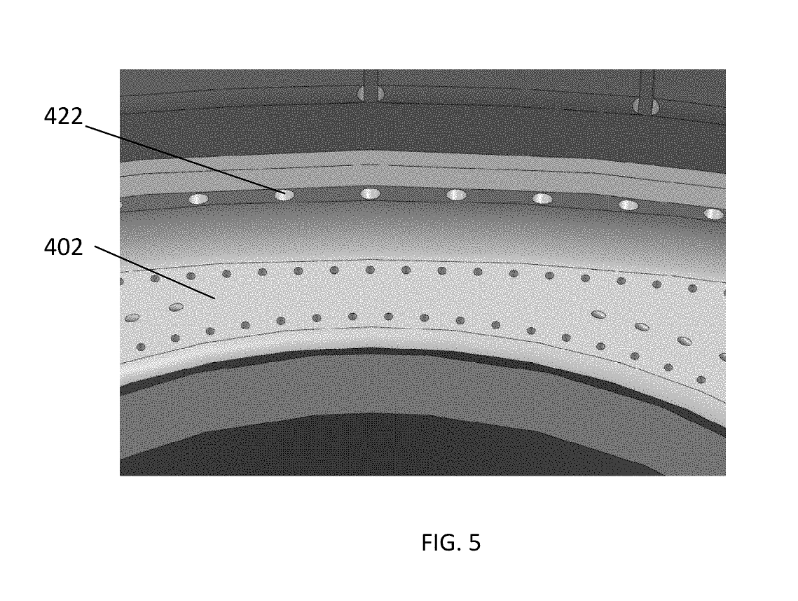

The cooling holes 422 in the formed lip 408 of the dome plate are shown in FIGS. 5 and 8. The cooling holes 422 are drilled generally perpendicular to the lip 408, as shown in FIG. 8 and are generally equally spaced about the lip 408 so as to provide uniform cooling to the lip 408. Furthermore, by drilling the cooling holes 408 after the dome plate 402 is formed, the holes 408 will have a round shape and are not imparted with stress creating micro-cracks found in prior art dome plates.

The present invention also incorporates a larger radius when forming the lip 408 than prior art dome plates. The preferred radius for the interface between the lip 408 and dome plate 402 is approximately 1.5 times the thickness of the dome plate 402. This larger radius results in lower operating stresses in the radius region of the lip 408. As previously discussed, the prior art dome plate had a peak operating stress of approximately 158 ksi. Through the radius design of the lip 408 being approximately 1.5 times the thickness of the dome plate 402 and given improved manufacturing techniques discussed herein, the present invention results in an operating stress of only about 141 ksi, a reduction of approximately 10% over prior art designs.

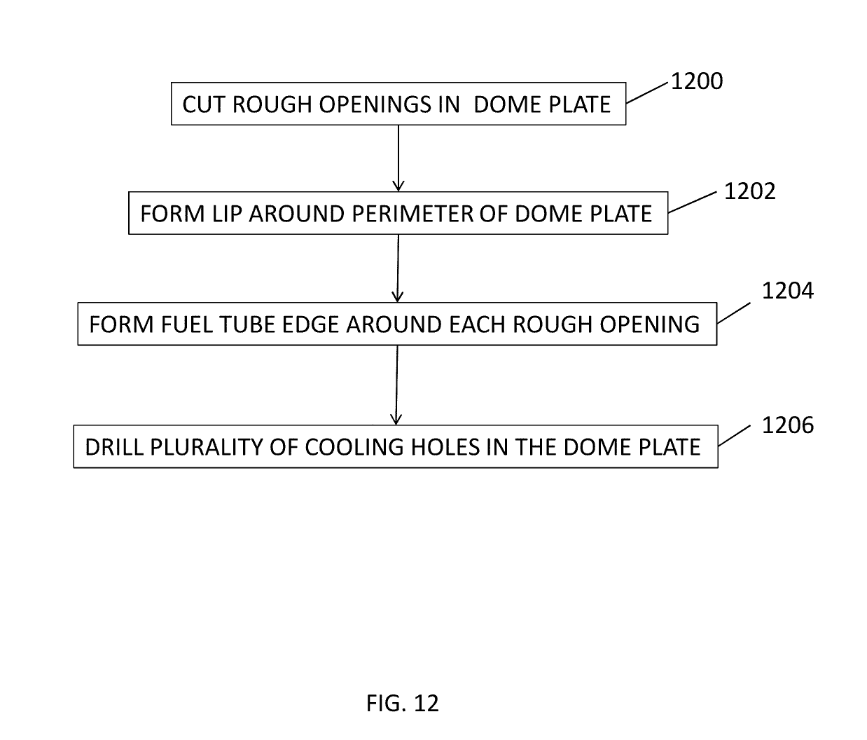

Referring now to FIG. 12, an outline of the manufacturing process is provided. Specifically, in a step 1200, rough openings are cut in the dome plate. These rough openings provide the openings for the fuel tubes to be attached to the dome plate. Then, in a step 1202, the lip around the perimeter of the dome plate is formed. In a step 1204, the edge around each opening is formed to provide the interface for welding of the fuel tubes. The edge around each opening extends away from the opening by approximately 0.375 inches, a distance sufficient to prevent any impact to the size and shape of the cooling holes by heat associated with welding the fuel tubes to the dome plate. Depending on the forming process utilized, it is possible that these forming processes occur simultaneously, possibly utilizing the same tooling. Then, once the edges and lips of the dome plate are formed, the plurality of cooling holes is drilled in the dome plate in a step 1206, including the portion in the lip.

Although not depicted, the dome plate of the cap assembly may also include a thermal barrier coating applied to the side of the dome plate facing the combustion zone, and thus exposed to, the hot combustion gases. A thermal barrier coating is preferably applied after the forming operations have been completed on the dome plate and before the holes are drilled in the dome plate. Drilling the holes after the coating is applied reduces tendency for coating material to cover or partially block the cooling holes.

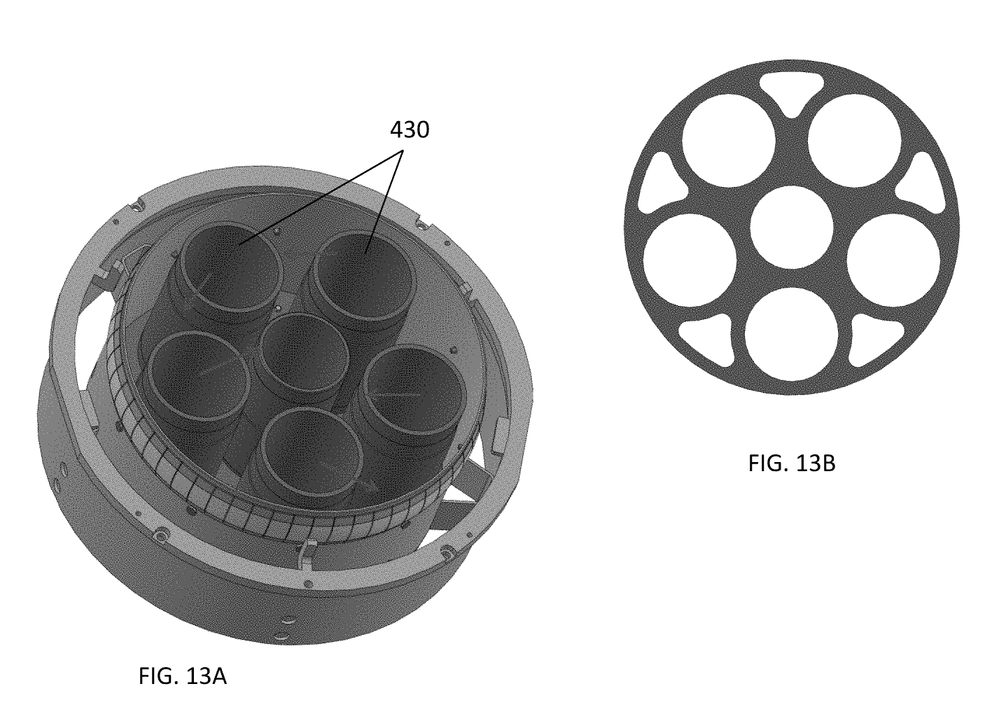

The present invention also provides an improved inspection and assembly technique for use with repairing cap assemblies to counteract stresses incurred during operation. That is, during operation of the cap assembly, the cap assembly temperature increases significantly due to its proximity to the flame front. The cap assembly 400 also includes premix tubes 430 for mixing fuel and air prior to injection, where the premix tubes 430 engage a corresponding fuel tube 416. At the interface between the premix tubes 430 and the fuel tubes 416/dome plate 402, the premix tubes 430 are operating at approximately 1200 deg. F. At such an operating temperature, the premix tubes 430 have shown evidence of thermal distortion, where the distortion occurs in a variety of directions, as shown by the arrows in FIG. 13A. The thermal distortion of the premix tubes on the dome plate 402 imparts an undesirable stress on the dome plate 402, further contributing to the stress and resulting part failures.

Often times, it is not necessary to replace the premix tubes 430 during a standard overhaul and repair of the cap assembly 400 as the premix tubes 430 rarely exhibit thermal damage or excessive wear. However, as discussed above, frequently the dome plate 402 does need to be removed and replaced due to cracking. However, placing a new dome plate 402 with fuel tubes 416 in the “new” condition in contact with premix tubes 430 which have distorted due to prior operation, can result in further unwanted stresses being imparted to the cap assembly at the dome plate 402. This condition can be verified by placing a “go no-go” gauge, similar to that shown in FIG. 13B over the premix tubes 430. This gauge will determine whether any thermal distortion is present in the premix tubes 430. Where thermal distortion is found, it is advantageous to take the premix tubes 430 and change their orientation slightly by removing a portion of the material from the wall of the premix tube through a machining operation. The amount of material to be removed can vary depending on the amount of thermal distortion, but some premix tubes have required material removal upwards of about 0.030 inches. Changing the orientation of the premix tubes 430 with respect to the new dome plate 402 reduces any stress applied to the dome plate 402 by the premix tubes 430 by reducing the interference with the premix tubes 430.

While the invention has been described in what is known as presently the preferred embodiment, it is to be understood that the invention is not to be limited to the disclosed embodiment but, on the contrary, is intended to cover various modifications and equivalent arrangements within the scope of the following claims. The present invention has been described in relation to particular embodiments, which are intended in all respects to be illustrative rather than restrictive.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

1. A cap assembly for a gas turbine engine comprising:
an outer ring;
a dome plate having a plurality of openings, a plurality of formed edges around the plurality of openings and a formed lip around a perimeter of the dome plate;
an outer band secured to the formed lip;
a plurality of fuel tubes secured to each of the plurality of openings such that fuel cups have constant diameter proximate the plurality of openings so as to provide a uniform weld joint for securing the fuel tubes to the formed edges; and,
a plurality of cooling holes generally equally spaced about the formed lip, the plurality of cooling holes have a constant circular shape.

2. The cap assembly of claim 1, wherein the plurality of formed edges extend a distance away from the dome plate such that a weld between the dome plate and fuel tube is free of heat affected deterioration in the formed edges.

3. The cap assembly of claim 2, wherein the formed edges extend a distance away from the dome plate that is at least eight times a thickness of the dome plate.

4. The cap assembly of claim 1, wherein the fuel tubes are extruded from a disk of raw material and formed to have a uniform diameter.

5. The cap assembly of claim 1, wherein the outer band of the cap assembly is generally evenly cooled by a supply of cooling air passed through the plurality of cooling holes.

6. The cap assembly of claim 1 further comprising a radius between the dome plate and the formed lip where the radius is approximately 1.5 times a thickness of the dome plate.

7. A method of fabricating a dome plate for a combustor cap assembly comprising:
cutting a plurality of rough openings in the dome plate for a plurality of fuel tubes;
forming a lip around a perimeter of the dome plate;
forming a fuel tube edge around each of the rough openings; and,
drilling a plurality of cooling holes in the dome plate;
wherein a portion of the plurality of cooling holes are drilled in the lip of the dome plate.

8. The method of claim 7 further comprising securing a fuel tube to the fuel tube edge of the rough opening.

9. The method of claim 8, wherein the lip is generally perpendicular to the dome plate.

10. The method of claim 7, wherein the cooling holes in the lip are generally equally spaced about an outer surface of the lip.

11. The method of claim 7, wherein the lip has a radius of at least 1.5 times a thickness of the dome plate.

12. The method of claim 7, wherein the lip extends a distance from the dome plate and within an outer band of the combustor cap assembly.

13. The method of claim 7, wherein the plurality of cooling holes is drilled both perpendicular to the dome plate and at a surface angle less than 90 degrees relative to the dome plate.

14. A method of reducing stress applied to a dome plate of a cap assembly for a gas turbine combustor, the cap assembly having a dome plate and a plurality of fuel tubes secured to the dome plate and a plurality of premix tubes engaging a corresponding fuel tube, the method comprising:
determining an orientation for the plurality of premix tubes;
identifying one or more premix tubes having an orientation causing a load to be applied to a corresponding fuel tube; and,
removing excess material on an outer surface of the one or more premix tubes.

15. The method of claim 14, wherein an inspection tool is utilized to determine thermal distortion in one or more of the premix tubes.

16. The method of claim 15 further comprising the step of placing the inspection tool over the one or more premix tubes and determining any contact between the one or more premix tubes and the inspection tool.

17. The method of claim 14, wherein the dome plate and premix tubes are new and the plurality of fuel tubes have previously operated in the gas turbine combustor.
